(19) United States
(12) Patent Application Publication
(10) Pub. No.: US 2023/0214957 A1
(43) Pub. Date: Jul. 6, 2023

(54) METHOD AND APPARATUS FOR COMBINING WARPED IMAGES BASED ON DEPTH DISTRIBUTION

(71) Applicant: ELECTRONICS AND TELECOMMUNICATIONS RESEARCH INSTITUTE, Daejeon (KR)

(72) Inventors: Sang-Woon KWAK, Daejeon (KR); Joung-Il YUN, Daejeon (KR)

(21) Appl. No.: 17/852,455

(22) Filed: Jun. 29, 2022

(30) Foreign Application Priority Data
Jan. 3, 2022 (KR) 10-2022-0000334

(51) Int. Cl. G06T 3/00; G06T 5/00; G06T 5/50

(52) U.S. Cl. CPC G06T 3/0093; G06T 5/005; G06T 5/50; G06T 2207/10028; G06T 2207/10024

(57) ABSTRACT

Disclosed herein is a method for blending warped images based on depth distribution. The method includes generating images warped to a virtual viewpoint using input images, generating a blended warped image based on the warped images, and generating a final virtual viewpoint image by applying inpainting to the blended warped image.

### CROSS REFERENCE TO RELATED APPLICATION

This application claims the benefit of Korean Patent Application No. 10-2022-0000334, filed Jan. 3, 2022, which is hereby incorporated by reference in its entirety into this application.

### BACKGROUND OF THE INVENTION

### 1. Technical Field

The present invention relates generally to technology for blending warped images for synthesis of a virtual viewpoint image.

More particularly, the present invention relates to technology for generating a blended image based on depth distribution of multiple generated warped images.

### 2. Description of Related Art

In order to provide a high degree of immersion to users of immersive media, such as Virtual Reality (VR), it is important to provide view images that support 6 Degrees of Freedom (DoF). Provision of a 6DoF view means providing a user with motion parallax according to 3DoF of rotational motion around a roll axis, a yaw axis, and a pitch axis and according to 3DoF of forward/backward, upward/downward, and leftward/rightward translation. When an appropriate view image that provides motion parallax according to the motion of a user is provided, the user may feel a high sense of immersion and realism.

However, in the case of image content based on actual images rather than computer graphic images, it is very difficult to acquire all view images providing 6DoF in advance and provide the same, so it is necessary to synthesize virtual views.

### DOCUMENTS OF RELATED ART

(Patent Document 1) Korean Patent Application Publication No. 10-2011-0090366, titled “Apparatus and method for image processing”.

### SUMMARY OF THE INVENTION

An object of the present invention is to provide a method for generating a blended warped image for improving the quality of a virtual viewpoint image.

Another object of the present invention is to provide a reliable method for blending warped images using depth distribution generated based on multiple warped images.

In order to accomplish the above objects, a method for blending warped images based on depth distribution according to an embodiment of the present invention includes generating images warped to a virtual viewpoint using input images, generating a blended warped image based on the warped images, and generating a final virtual viewpoint image by applying inpainting to the blended warped image.

Here, generating the blended warped image may include calculating the distribution of depth values for respective patches of the warped images, calculating a weight for each interval of the distribution of the depth values, and calculating a weighted average value for the color of a patch of each of the warped images in the distribution of the depth values.

Here, the distribution of the depth values may include density information of each of a preset number of depth intervals, which is calculated based on the number of patches included in the depth interval.

Here, the size of each of the depth intervals may be proportional to the reciprocal of the depth value of the depth interval.

Here, the density information of each of the depth intervals may be calculated based on the reciprocal of the area of a patch included in the depth interval.

Here, calculating the weight for each interval may comprise calculating the weight for each interval based on a normalized object density of each interval and transmittance information proportional to the reciprocal of a density value accumulated to a specific depth interval.

Here, calculating the weight for each interval may comprise calculating the weight for each interval based on consensus information proportional to the ratio of the number of patches in a specific depth interval to the number of patches in all depth intervals.

Here, calculating the weighted average value may comprise calculating the weighted average value by normalizing weights for intervals remaining after intervals having a density less than a preset value, among intervals of the distribution of the depth values, are removed as outliers.

Here, calculating the weighted average value may comprise assigning the calculated weight for each interval to a patch present in the interval and calculating the weighted average value for the color of the patch.

Also, in order to accomplish the above objects, an apparatus for blending warped images based on depth distribution according to an embodiment of the present invention includes memory in which at least one program is recorded and a processor for executing the program. The program includes instructions for generating images warped to a virtual viewpoint using input images, generating a blended warped image based on the warped images, and generating a final virtual viewpoint image by applying inpainting to the blended warped image.

Here, generating the blended warped image may include calculating the distribution of depth values for respective patches of the warped images, calculating a weight for each interval of the distribution of the depth values, and calculating a weighted average value for the color of a patch of each of the warped images in the distribution of the depth values.

Here, the distribution of the depth values may include density information of each of a preset number of depth intervals, which is calculated based on the number of patches included in the depth interval.

Here, the size of each of the depth intervals may be proportional to the reciprocal of the depth value of the depth interval.

Here, the density information of each of the depth intervals may be calculated based on the reciprocal of the area of a patch included in the depth interval.

Here, calculating the weight for each interval may comprise calculating the weight for each interval based on a normalized object density for each interval and transmittance information proportional to the reciprocal of a density value accumulated to a specific depth interval.

Here, calculating the weight for each interval may comprise calculating the weight for each interval based on consensus information proportional to the ratio of the number of patches in a specific depth interval to the number of patches in all depth intervals.

Here, calculating the weighted average value may comprise calculating the weighted average value by normalizing weights for intervals remaining after intervals having a density less than a preset value, among intervals of the distribution of the depth values, are removed as outliers.

Here, calculating the weighted average value may comprise assigning the calculated weight for each interval to a patch present in the interval and calculating the weighted average value for the color of the patch.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating a process for synthesizing a virtual view based on 3D warping;

FIG. 2 is a view conceptually illustrating a process for generating a virtual viewpoint image from an input viewpoint image;

FIG. 3 is a view conceptually illustrating a process for blending multiple warped images;

FIG. 4 is a view illustrating an example of a blending weight;

FIG. 5 is a flowchart illustrating a method for blending warped images based on depth distribution according to an embodiment of the present invention;

FIG. 6 is a flowchart illustrating in detail a step of generating a blended warped image;

FIG. 7 is a view illustrating the depth distribution of pixels warped to a virtual viewpoint;

FIG. 8 is a view conceptually illustrating that the depth range of FIG. 7 is evenly divided;

FIG. 9 is a view conceptually illustrating that the depth range of FIG. 7 is divided such that the size of each interval is proportional to the reciprocal of a depth value;

FIG. 10 is a view conceptually illustrating the distribution of patches in a depth interval of a specific pixel position of a virtual view;

FIG. 11 is a view conceptually illustrating a process for calculating a density value corresponding to a specific patch;

FIG. 12 is a view conceptually illustrating the depth distribution at a specific pixel position;

FIG. 13 is a view conceptually illustrating that a patch of an input image is warped to a virtual viewpoint;

FIG. 14 is a view conceptually illustrating a density value depending on the size of a warped patch;

FIG. 15 is a view conceptually illustrating setting of a blending weight based on a normalized object density value;

FIG. 16 is a view conceptually illustrating a method for setting a blending weight depending on transmittance in a depth interval;

FIG. 17 is a view conceptually illustrating setting of a blending weight using consensus based on the density ratio of a patch; and

FIG. 18 is a view illustrating the configuration of a computer system according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

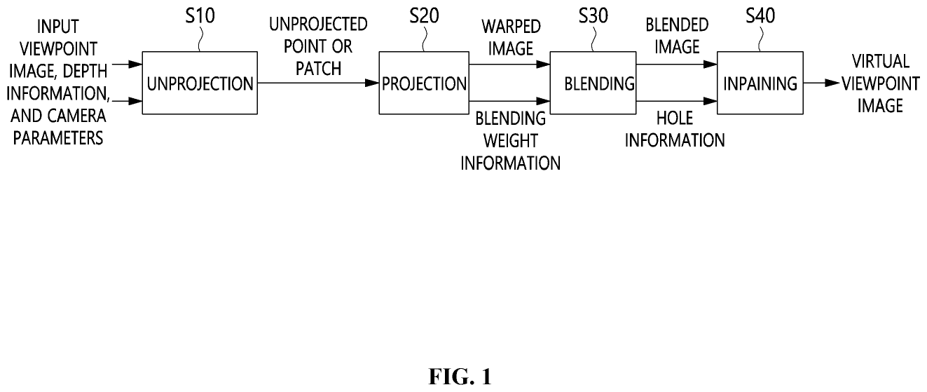

FIG. 1 is a flowchart illustrating a process for synthesizing a virtual view based on 3D warping.

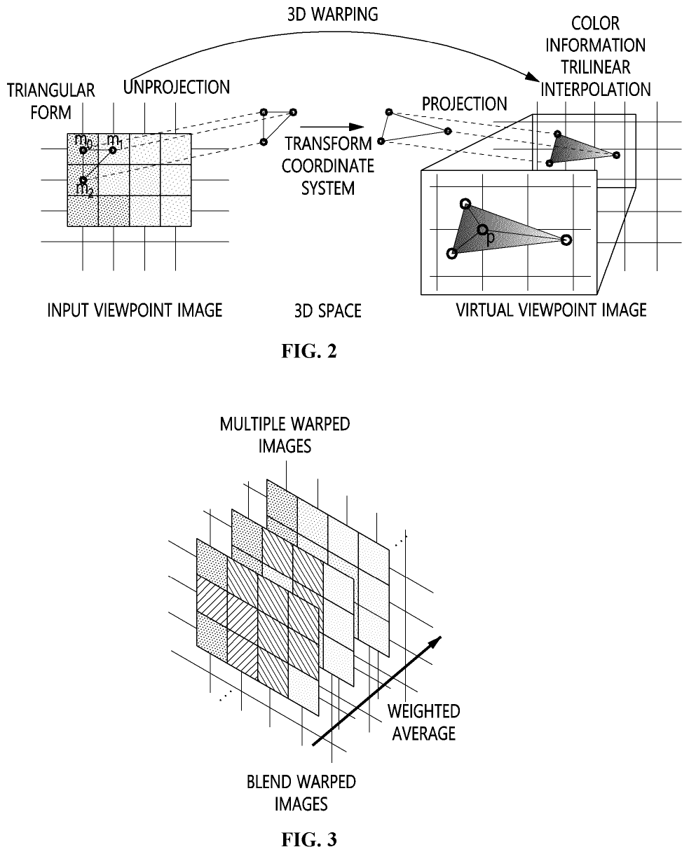

FIG. 2 is a view conceptually illustrating a process for generating a virtual viewpoint image from an input viewpoint image.

FIG. 3 is a view conceptually illustrating a process for blending multiple warped images.

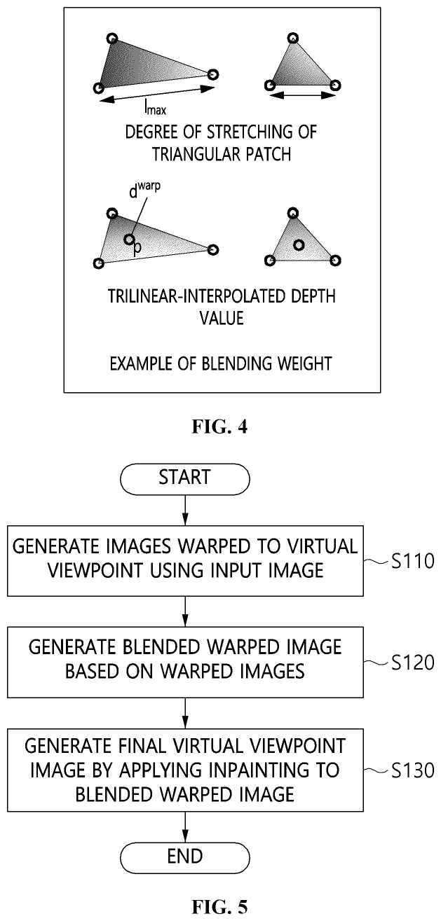

FIG. 4 is a view illustrating an example of a blending weight.

Hereinafter, a method for synthesizing a virtual viewpoint image will be described in detail with reference to FIGS. 1 to 4.

Synthesis of a virtual viewpoint image refers to generation of an image from the viewpoint of a user at a virtual position, which is not capable of being acquired based on a limited number of input images. Various methods may be used as virtual-view synthesis methods, and a method of using 3D warping is a representative method.

Virtual-view synthesis based on 3D warping is a method of unprojecting input viewpoint image information into 3D space using a given input viewpoint image along with depth information and camera parameters pertaining thereto and again projecting the same to the image coordinates of a virtual viewpoint using the camera parameters of the position of a virtual viewpoint, thereby acquiring a virtual viewpoint image.

Here, unprojection and projection are collectively referred to as 3D warping, and when warped images are acquired as described above, the warped images are suitably blended using a weighted average, whereby a blended image is acquired. When there is a hole area that is not filled even after blending, postprocessing, such as inpainting, is performed, whereby a final virtual viewpoint image is acquired.

When warping is performed for individual pixels in the process of 3D warping of an image, small holes, such as cracks, may be generated in a virtual viewpoint image, so warping in units of patches may be considered according to need. Here, a patch may be a super-pixel acquired by extending an individual pixel, or a triangular or rectangular patch acquired by connecting adjacent pixels.

For example, warping in units of triangular patches may be performed in such a way that each triangle is formed using three adjacent pixels in an input viewpoint image, 3D warping is performed on the triangle, and trilinear interpolation is performed on the colors inside the triangle projected to the coordinates of a virtual viewpoint image so as to determine the color of the warped image.

When multiple warped images are acquired, weighted blending is applied thereto, whereby a single blended image from a virtual viewpoint position is acquired. Here, the size of a patch may be considered to be a blending weight.

For example, when a patch is formed in a triangle unit, the extent to which the triangle is stretched according to a change in a viewpoint is measured, and the reciprocal thereof may be reflected to a blending weight. Also, various blending weights, such as the baseline between cameras, the similarity between the directions of rays directed to the same point in space, and the like, are combined, whereby blending performance may be optimized.

Because depth information is generally estimated from image information, it is likely that depth information pertaining to the same point in space may differ in multiple input images. When such input images are warped to a single virtual viewpoint position, inconsistency of depth values may cause degradation in the quality of the blended image and the quality of the final synthesis image.

Particularly, when a virtual view is synthesized using warping in units of patches, because the depth values warped to a single pixel position in a virtual viewpoint image are values interpolated in individual patches, it is more difficult for the multiple values to be consistent with each other, and an artifact may be generated in a part in which large consistency occurs.

FIG. 5 is a flowchart illustrating a method for blending warped images based on depth distribution according to an embodiment of the present invention.

Referring to FIG. 5, the method for blending warped images based on depth distribution according to an embodiment of the present invention includes generating images warped to a virtual viewpoint using input images at step S110, generating a blended warped image based on the warped images at step S120, and generating a final virtual viewpoint image by applying inpainting to the blended warped image at step S130.

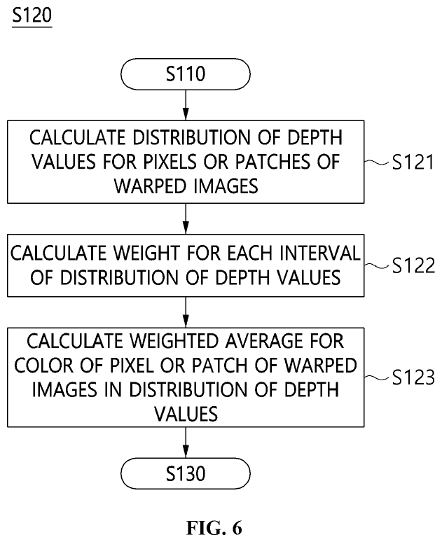

FIG. 6 is a flowchart illustrating in detail a step of generating a blended warped image.

Referring to FIG. 6, generating a blended warped image at step S120 may include calculating the distribution of depth values for the respective patches of warped images at step S121, calculating a weight for each interval of the distribution of the depth values at step S122, and calculating a weighted average value for the color of each of the patches of the warped images in the distribution of the depth values at step S123.

Here, when a preset number of depth intervals is present, the distribution of the depth values may include density information of each of the depth intervals, which is calculated based on the number of patches included therein.

Here, the size of each of the depth intervals may be proportional to the reciprocal of the depth value of the depth interval. The sizes of the respective depth intervals are set as described above, whereby the foreground part of an image may be more densely divided than the background part thereof. Also, the sizes of depth intervals may be adaptively set by reflecting information about a depth area in which an object of interest in an image is present.

Here, the density information of each interval may be calculated based on the reciprocal of the area of a patch included therein. That is, because a different number of pixels or patches is included at a specific pixel position in a virtual viewpoint image and because the pixels or patches are stretched to different degrees, the density value may be calculated based on such information.

Here, calculating a weight for each interval at step S122 comprises calculating a weight for each interval based on the normalized object density for each interval and on transmittance information proportional to the reciprocal of a density value accumulated to a specific depth interval.

Here, calculating a weight for each interval at step S122 may comprise calculating a weight for each interval based on consensus information proportional to the ratio of the number of patches within a specific depth interval to the number of patches across all of the depth intervals.

Here, a function capable of representing the density of a warped patch may be modeled and applied to the step (S122) of calculating a weight for each interval, but the scope of the present invention is not limited thereto.

Here, calculating a weighted average at step S123 may comprise calculating a weighted average value by normalizing weights for intervals remaining after intervals having a density less than a preset value, among the intervals of the distribution of the depth values, are removed as outliers.

Here, at the step (S123) of calculating a weighted average, the calculated weight for each interval is assigned to the patches present in the corresponding interval, and the weighted average for the color of the patch may be calculated.

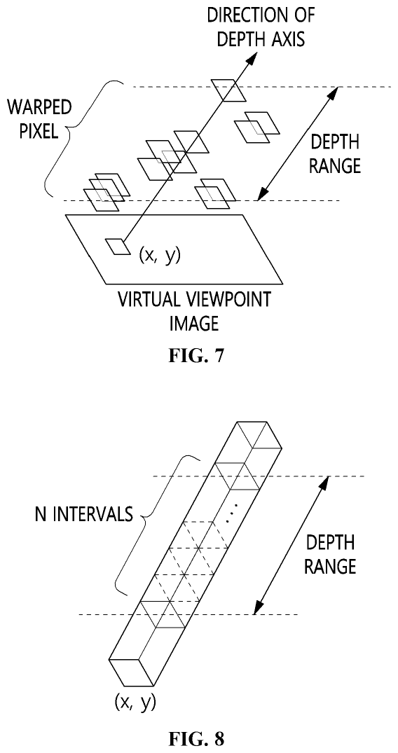

Hereinafter, a method for blending warped images based on depth distribution according to an embodiment of the present invention will be described in more detail with reference to FIGS. 7 to 17.

In order to synthesize a virtual viewpoint image from multiple input images, the overall process of the present invention includes a process for 3D warping to a virtual viewpoint position using input images and depth information, a process for weighted blending of the multiple warped images into a single blended image using appropriate weights, and a postprocessing process for generating a final virtual viewpoint image by applying inpainting to the blended image.

Particularly, a blending weight based on the depth distribution of warped pixels or patches is calculated in the process of blending the warped images, and a problem of inconsistency of the depths of the warped pixels is mitigated using the blending weight, whereby the present invention provides a blending method capable of improving the quality of a virtual viewpoint image.

The blending method includes a means for calculating the distribution of depth values, a means for acquiring a blending weight, and a means for calculating a weighted average of warped images.

FIG. 7 is a view illustrating the depth distribution of pixels warped to a virtual viewpoint.

FIG. 8 is a view conceptually illustrating that the depth range of FIG. 7 is evenly divided.

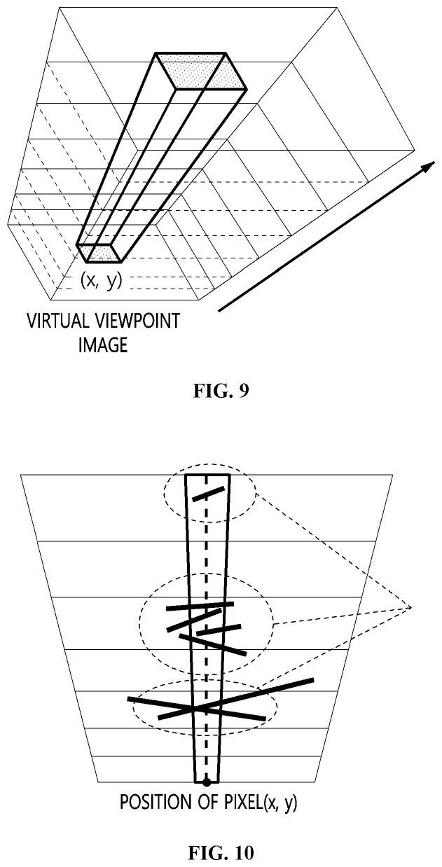

FIG. 9 is a view conceptually illustrating that the depth range of FIG. 7 is divided such that the size of each interval is proportional to the reciprocal of a depth value.

First, the means for calculating the distribution of depth values is a means for calculating the distribution of warped pixels or patches in a depth direction. At a virtual viewpoint position, the entire depth range of the warped pixels or patches is divided into N finite intervals, and the density of each of the depth intervals may be calculated based on the number and sizes of warped patches included in the depth interval.

The finite intervals may be acquired by evenly dividing the entire depth range, as in the embodiment of FIG. 8, by dividing the entire depth range such that the size of each interval is proportional to the reciprocal of the depth value thereof, as in the embodiment of FIG. 9, or by adaptively dividing the entire depth range if a depth area including an object of interest is known in advance.

Also, The finite intervals may be acquired by dividing the entire depth range such that the size of each interval is proportional to the depth value thereof.

FIG. 10 is a view conceptually illustrating the distribution of patches in a depth interval of a specific pixel position in a virtual view.

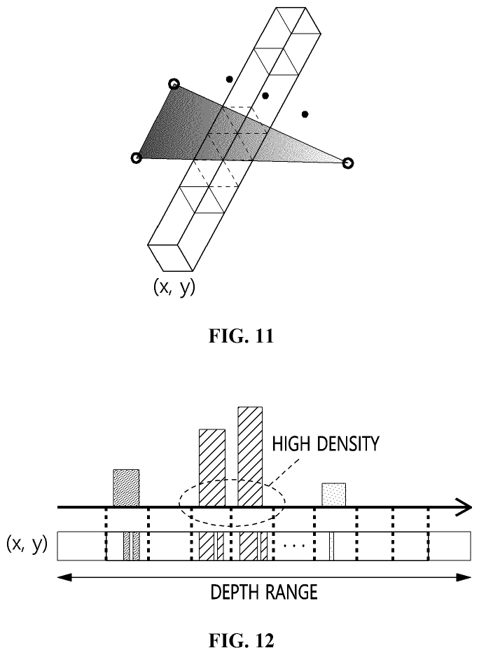

FIG. 11 is a view conceptually illustrating a process of calculating a density value corresponding to a specific patch.

FIG. 12 is a view conceptually illustrating the depth distribution at a specific pixel position.

The density of each of the depth intervals acquired by finitely dividing the entire depth range may be calculated based on the number and sizes of pixels or patches warped to the corresponding depth interval. As in the embodiment of FIG. 10, based on a specific pixel position in a virtual viewpoint image, each depth interval may include a different number of pixels or patches, and the extent to which these pixels or patches are stretched may also be different. Accordingly, a value corresponding to the density may be approximately calculated based thereon.

When a density value of each depth interval is assigned to the corresponding depth area, as in the embodiment of FIG. 11, the distribution of depth values at a specific pixel position in a virtual viewpoint image may be calculated as shown in FIG. 12, and a region having high density and a region having low density may be identified.

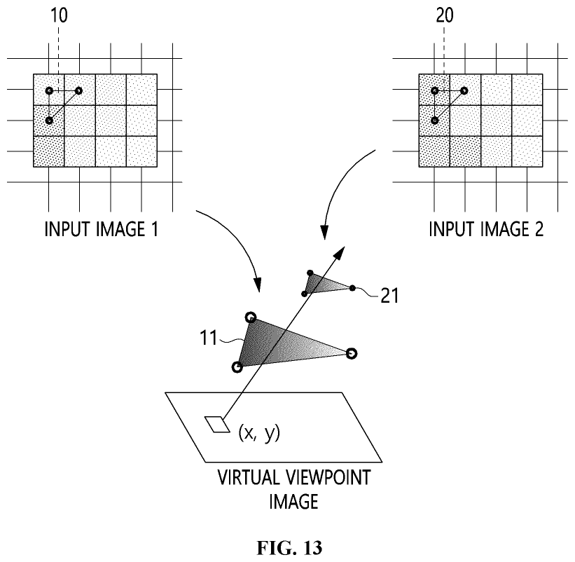

FIG. 13 is a view conceptually illustrating warping of a patch of an input image to a virtual view.

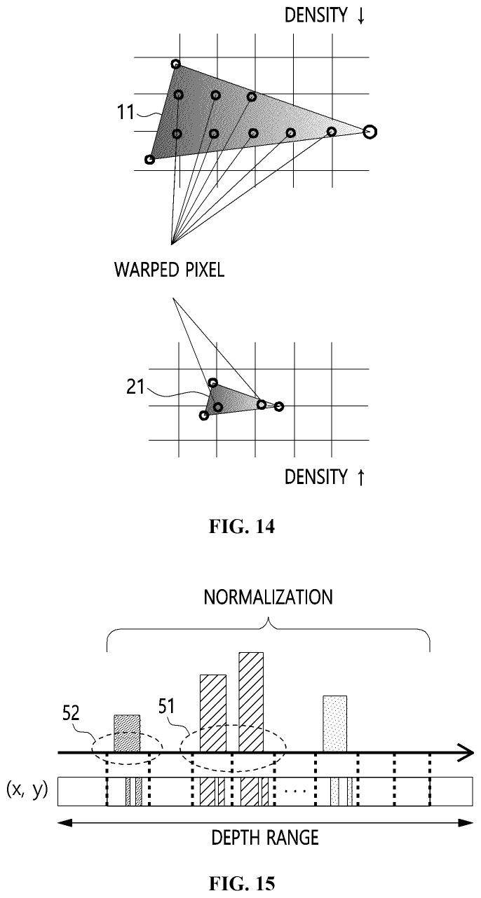

FIG. 14 is a view conceptually illustrating a density value depending on the size of a warped patch.

The density value of each depth interval may be calculated using the total number of warped patches or pixels included in the depth interval or using the sum of values that are proportional to the reciprocals of the areas of the warped patches, or another function value capable of representing the density of a warped patch may be modeled and applied. The method of calculating a density value is not limited to any specific method in the present invention.

The reason that the value corresponding to density approximates the sum of the values that are proportional to the reciprocals of the areas of the warped patches is described with reference to FIGS. 13 and 14. In multiple input images 10 and 20, unit patches, each formed of adjacent pixels, may be assumed to have the same amount of texture information (the same texture density) for the same area. When these unit patches formed in the respective input images are warped to the position of a virtual viewpoint image, the unit patches may have different sizes and shapes depending on a change in the viewpoint position and on scene geometry, as in the example illustrated in FIG. 13.

Here, because the color of a pixel within the warped patch is determined by interpolation, the larger the area 11 of the patch, the more widely the quantity of information is spread, and the patch may be understood as having relatively low density, as shown in FIG. 14. Also, when the area 21 of the patch is small, the patch may be understood as having high density.

The means for acquiring a blending weight is a means for acquiring a blending weight for each of the depth intervals at each pixel position in a virtual viewpoint image using the calculated distribution of the depth values. The blending weight for each depth interval may include at least one of an object density of each interval, which is normalized such that the accumulated total of density values calculated along the depth direction of the virtual viewpoint image becomes 1, transmittance that is modeled so as to be proportional to the reciprocal of the total density value accumulated to a specific depth interval, and consensus that is modeled so as to represent the density ratio of the patches warped to the corresponding depth interval to a total number of patches warped to the corresponding pixel position.

FIG. 15 is a view conceptually illustrating setting of a blending weight based on a normalized object density value.

Referring to FIG. 15, a blending weight is normalized such that the accumulated density value in the depth range is 1 based on the depth distribution calculated at the position of coordinates (x, y) in a virtual viewpoint image, whereby a high blending weight may be assigned to a depth area in which a relatively large number of patches is distributed. For example, the area 51 having high density may be assigned a high weight, but the area 52 having low density may be assigned a low weight.

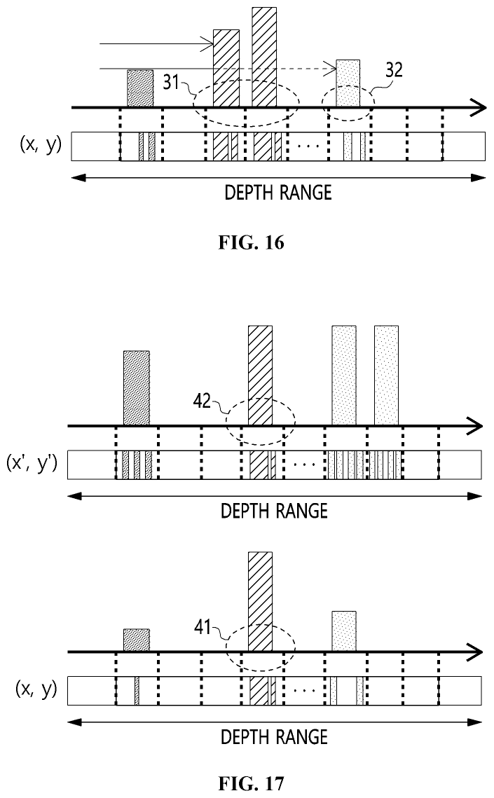

FIG. 16 is a view conceptually illustrating a method for setting a blending weight depending on the transmittance in a depth interval.

Referring to FIG. 16, when the density of patches accumulated to the (d−1)-th depth interval is high, transmittance in the d-th depth interval may be low due to occlusion, so a low blending weight may be assigned. Here, because transmittance of the area 31 is high, a high weight may be assigned, and because transmittance of the area 32 is low, a low weight may be assigned.

FIG. 17 is a view conceptually illustrating setting of a blending weight using consensus based on the density ratio of patches.

Referring to FIG. 17, consensus is calculated using the density ratio of patches warped to a corresponding depth interval to all of the pixels or patches warped to a corresponding pixel position, and a blending weight may be assigned based thereon. Because the area 41 has high consensus, a high weight may be assigned thereto, but because the area 42 has low consensus, a low weight may be assigned thereto.

Above, the methods of assigning weights have been described with reference to FIGS. 15 to 17, but the scope of the present invention is not limited thereto, and various methods may be used.

The means for calculating a weighted average of warped images is a means for acquiring a single blended image by taking a weighted average of the colors of warped images using the blending weight acquired as described above. The method for calculating a weighted average may include at least one of a method of taking a weighted average of colors after assigning the blending weight for each interval to the patches included in the corresponding interval, a method of normalizing the calculated weight combined with another existing weight and using the normalized weight as the blending weight, and a method of taking a weighted average of colors by normalizing weights for intervals remaining after removing intervals that are determined as outliers when the calculated distribution of the depth values is equal to or less than a certain threshold value.

Hereinafter, a process of acquiring a blended image by taking a weighted average of the colors of warped images will be described in detail. The color c(x, y) at a pixel position (x, y) in a virtual viewpoint image may be acquired using the weighted average of color cᵢ(x, y) of the pixel or patch of the i-th input image warped to the corresponding position. This may be represented as shown in Equation (1) below:

$$c ( x , y ) = {\sum }_{i} {ω}_{i} ( x , y ) \cdot {c}_{i} ( x , y ) \qquad ( 1 )$$

Here, wᵢ(x, y) is the blending weight at the position (x, y) for the i-th warped image, and satisfies Σwᵢ(x, y)=1. Also, the blending weight based on the distribution of depth values, wᵢ^{D}(x, y), may take a form such as that shown in Equation (2) below:

$${ω}_{i}^{D} ( x , y ) = D ( x , y , d ) \cdot C ( x , y , d ) \cdot {\sum }_{k = 0}^{d - 1} T ( x , y , k ) \qquad ( 2 )$$

Here, d is the depth interval in which the pixel or patch at the position (x, y) of the i-th warped image is included. The above embodiment takes a form in which all of the term D( ) corresponding to object density, the term C( ) corresponding to consensus, and the term T( ) corresponding to transmittance are combined, and alternatively, the embodiment may include only some of these terms, depending on the application method. The weight based on the distribution of the depth values calculated in this way may be used as a blending weight without change, as shown in Equation (3) below:

ωᵢ(x,y)=ωᵢ^{D}(x,y) (3)

Also, this weight may be combined with a blending weight calculated using another method, normalized, and then used. Here, as the method of combining the weights, the product of the weights may be used, as shown in Equation (4) below:

ωᵢ(x,y)=ωᵢ^{D}(x,y)·ωᵢ^{others}(x,y) (4)

Alternatively, various methods such as a weighted sum using a ratio adjustment parameter as shown in Equation (5) below may be considered.

ωᵢ(x,y)=λ·ωᵢ^{D}(x,y)+(1−λ)·ωᵢ^{others}(x,y) (5)

Also, the method of removing an outlier by setting a weight equal to or less than a certain threshold to 0, as shown in Equation (6) below, may be applied.

$${ω}_{i}^{D} ( x , y ) = \{ \begin{matrix}0 , & if {ω}_{i}^{D} ( x , y ) < T \\ {ω}_{i}^{D} ( x , y ) , & otherwise\end{matrix} \qquad ( 6 )$$

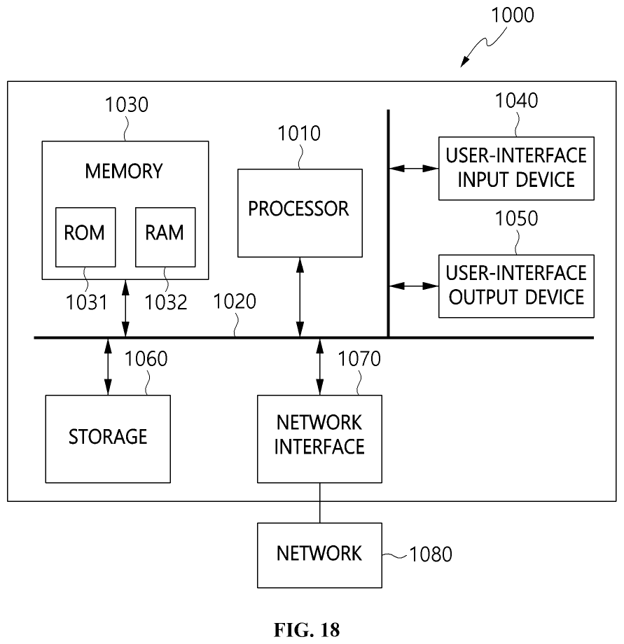

FIG. 18 is a view illustrating the configuration of a computer system according to an embodiment.

The apparatus for blending warped images based on depth distribution according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

The apparatus for blending warped images based on depth distribution according to an embodiment of the present invention includes memory 1030 in which at least one program is recorded and a processor 1010 for executing the program, and the program includes instructions for performing a step of generating images warped to a virtual viewpoint using input images, a step of generating a blended warped image based on the warped images, and a step of generating a final virtual viewpoint image by applying inpainting to the blended warped image.

Here, the step of generating a blended warped image may include calculating the distribution of depth values for the respective patches of the warped images, calculating a weight for each interval of the distribution of the depth values, and calculating a weighted average for the color of each of the patches of the warped images in the distribution of the depth values.

Here, the distribution of the depth values may include density information of each of a preset number of depth intervals, which is calculated based on the number of patches included in the corresponding interval.

Here, the size of each of the depth intervals may be proportional to the reciprocal of the depth value of the depth interval.

Here, the density information of each of the depth intervals may be calculated based on the reciprocal of the area of the patch included in the depth interval.

Here, calculating the weight for each interval may comprise calculating the weight for each interval based on a normalized object density of each interval and on transmittance information proportional to the reciprocal of a density value accumulated to a specific depth interval.

Here, calculating the weight for each interval may comprise calculating the weight for each interval based on consensus information proportional to the ratio of the number of patches in a specific depth interval to the number of patches in all of the depth intervals.

Here, calculating the weighted average may comprise calculating the weighted average by normalizing weights for intervals remaining after an interval having a density less than a preset value, among the intervals of the distribution of the depth values, is removed as an outlier.

Here, calculating the weighted average may comprise assigning the calculated weight for each interval to a patch present in the corresponding interval and calculating the weighted average of the color of the patch.

According to the present invention, a method for generating a blended warped image for improving the quality of a virtual viewpoint image may be provided.

Also, the present invention may provide a reliable method for blending warped images using depth distribution generated based on multiple warped images.

Specific implementations described in the present invention are embodiments and are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. A method for blending warped images based on depth distribution, comprising:
generating images warped to a virtual viewpoint using input images;
generating a blended warped image based on the warped images; and
generating a final virtual viewpoint image by applying inpainting to the blended warped image.

2. The method of claim 1, wherein generating the blended warped image includes
calculating a distribution of depth values for respective patches of the warped images;
calculating a weight for each interval of the distribution of the depth values; and
calculating a weighted average value for a color of a patch of each of the warped images.

3. The method of claim 2, wherein the distribution of the depth values includes density information of each of depth intervals, which is calculated based on a number of patches included in the depth interval.

4. The method of claim 3, wherein a size of each of the depth intervals is proportional to a reciprocal of a depth value of the depth interval.

5. The method of claim 3, wherein the density information of each of the depth intervals is calculated based on a reciprocal of an area of a patch included in the depth interval.

6. The method of claim 2, wherein calculating the weight for each interval comprises calculating the weight for each interval based on a normalized object density of each interval and transmittance information proportional to a reciprocal of a density value accumulated to a specific depth interval.

7. The method of claim 6, wherein calculating the weight for each interval comprises calculating the weight for each interval based on consensus information proportional to a ratio of a number of patches in a specific depth interval to a number of patches in all depth intervals.

8. The method of claim 2, wherein calculating the weighted average value comprises calculating the weighted average value by normalizing weights for intervals remaining after intervals having a density less than a preset value are removed.

9. The method of claim 2, wherein calculating the weighted average value comprises assigning the calculated weight for each interval to a patch present in the interval and calculating the weighted average value for the color of the patch.

10. An apparatus for blending warped images based on depth distribution, comprising:
memory in which at least one program is recorded; and
a processor for executing the program,
wherein the program includes instructions for performing:
generating images warped to a virtual viewpoint using input images,
generating a blended warped image based on the warped images, and
generating a final virtual viewpoint image by applying inpainting to the blended warped image.

11. The apparatus of claim 10, wherein the generating of the blended warped image includes:
calculating a distribution of depth values for respective patches of the warped images;
calculating a weight for each interval of the distribution of the depth values; and
calculating a weighted average value for a color of a patch of each of the warped images.

12. The apparatus of claim 11, wherein the distribution of the depth values includes density information of each of depth intervals, which is calculated based on a number of patches included in the depth interval.

13. The apparatus of claim 12, wherein a size of each of the depth intervals is proportional to a reciprocal of a depth value of the depth interval.

14. The apparatus of claim 12, wherein the density information of each of the depth intervals is calculated based on a reciprocal of an area of a patch included in the depth interval.

15. The apparatus of claim 11, wherein the calculating of the weight for each interval comprises calculating the weight for each interval based on a normalized object density for each interval and transmittance information proportional to a reciprocal of a density value accumulated to a specific depth interval.

16. The apparatus of claim 15, wherein the calculating of the weight for each interval comprises calculating the weight for each interval based on consensus information proportional to a ratio of a number of patches in a specific depth interval to a number of patches in all depth intervals.

17. The apparatus of claim 11, wherein the calculating of the weighted average value comprises calculating the weighted average value by normalizing weights for intervals remaining after intervals having a density less than a preset value are removed.

18. The apparatus of claim 11, wherein the calculating of the weighted average value comprises assigning the calculated weight for each interval to a patch present in the interval and calculating the weighted average value for the color of the patch.
